(19) United States
(12) Patent Application Publication
(10) Pub. No.: US 2014/0144828 A1
(43) Pub. Date: May 29, 2014

(54) Alkaline Water Converter

(71) Applicant: YIE LIN TECHNOLOGY CO., LTD., Toufen Township (TW)

(72) Inventor: Jiou-Kwei Chiu, Taipei (TW)

(73) Assignee: YIE LIN TECHNOLOGY CO., LTD., TOUFEN TOWNSHIP (TW)

(21) Appl. No.: 13/688,422

(22) Filed: Nov. 29, 2012

(51) Int. Cl. C02F 1/66

(52) U.S. Cl. CPC C02F 1/66
USPC 210/282

(57) ABSTRACT

An alkaline water converter includes a converter adapter detachably connectable to a water container, an alkaline filter component container connected to a bottom side of a through hole of the converter adapter for dipping in the drinking water in the water container to filtrate the drinking water and to convert the drinking water into alkaline water, a cap detachably attachable to the converter adapter to close the through hole, and a receptacle for accommodating the alkaline filter component container and the converter adapter after removal of the alkaline water converter from the water container.

### BACKGROUND OF THE INVENTION

1. Field of the Invention

The present invention relates to a wind decanter and more particularly, to a bottle-top wine for converting regular drinking water into alkaline water having smaller clusters of water molecules.

2. Description of the Related Art

Commercial bottled waters are commonly acidic. Home drinking water after filtered through a reverse osmosis device is still maintained acidic or weakly acidic. An acidic water or weakly acidic water is not suitable for drinking over a long period of time. Drinking acidic water or weakly acidic water over a long period of time can cause the body to produce uric acid, or to get gout and other ailments.

### SUMMARY OF THE INVENTION

The present invention has been accomplished under the circumstances in view. It is the main object of the present invention to provide an alkaline water converter, which can be detachably attached to a water container and dipped in the drinking water in the water container to filtrate the drinking water and to convert the drinking water into alkaline water when the user pours the drinking water out of the water container for service, so that the body of the user frequently drinking the alkaline water is not easy to produce uric acid, or to cause gout and other ailments

It is another object of the present invention to provide an alkaline water converter, which can be received in a receptacle when not used, conveniently for carrying.

To achieve these and other objects of the present invention, an alkaline water converter comprises a converter adapter detachably connectable to a water container, an alkaline filter component container connected to a bottom side of a through hole of the converter adapter for dipping in the drinking water in the water container to filtrate the drinking water and to convert the drinking water into alkaline water, a cap detachably attachable to the converter adapter to close the through hole, and a receptacle for accommodating the alkaline filter component container and the converter adapter after removal of the alkaline water converter from the water container.

The alkaline water has smaller clusters of water molecules capable of generating resonance frequency as high as 20,000 cycles per second. Further, the alkaline water contains minerals and trace elements that help the activation of enzymes in the body and start the immune system of the person drinking the alkaline water, enhancing the functioning of body organs and the excretion of toxic harmful substances. The alkalinity of the alkaline water can survive the digestive system and change the blood's or body's pH of the person drinking the alkaline water. Further, the redox potential of the alkaline water has an effect on oxygen radicals in the cells of the person drinking the alkaline water. Further, the alkaline water is better at hydrating or detoxifying than regular drinking water.

### BRIEF DESCRIPTION OF THE DRAWING

FIG. 1 is a longitudinal sectional view of a converter adapter for alkaline water converter in accordance with the present invention.

FIG. 2 is an elevational view of the converter adapter for alkaline water converter in accordance with the present invention.

FIG. 3 is an applied view of the present invention, illustrating the converter adapter attached to a water bottle and capped by a cap.

FIG. 4 is an exploded view of the alkaline water converter in accordance with the present invention.

FIG. 5 is an elevational assembly view of the alkaline water converter in accordance with the present invention.

### DETAILED DESCRIPTION OF THE INVENTION

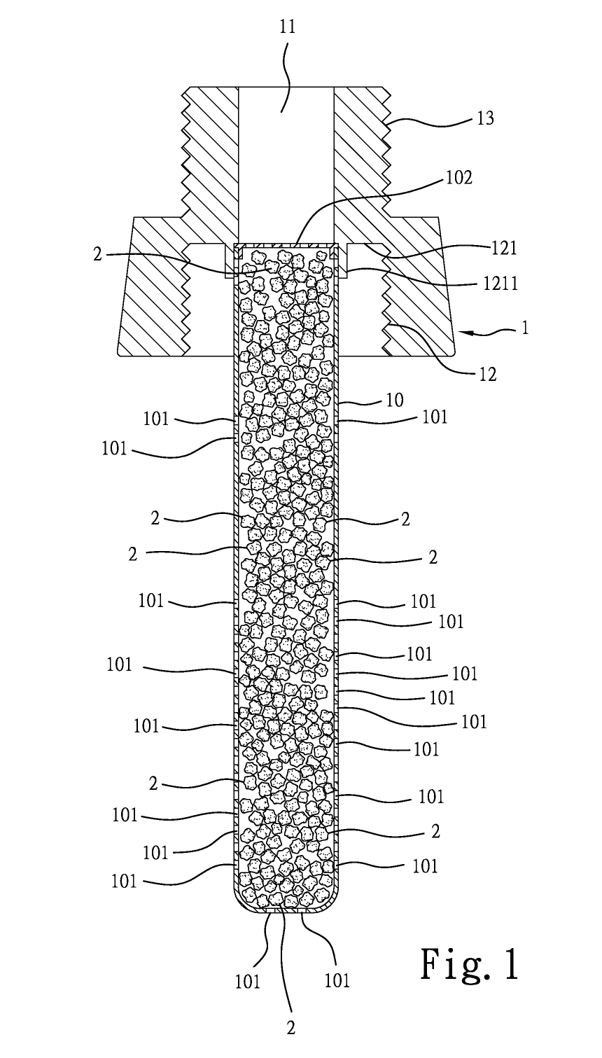

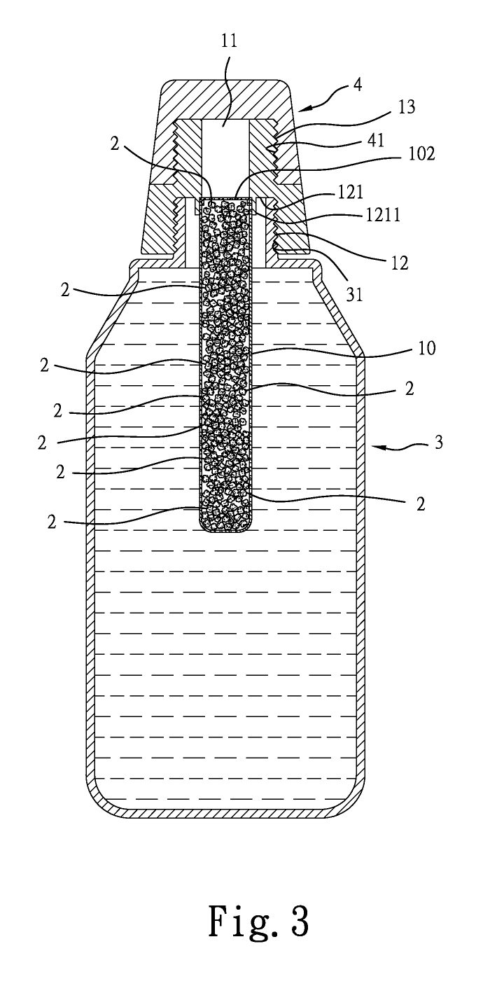

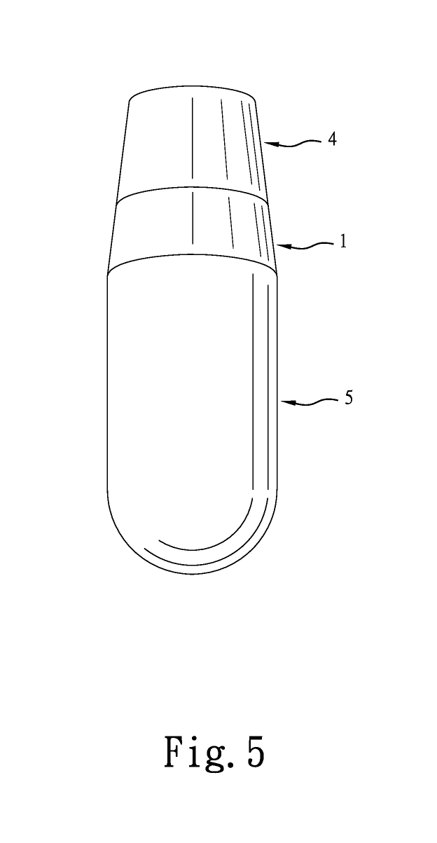

Referring to FIGS. 1-5, an alkaline water converter in accordance with the present invention is shown for use in a water bottle 3 (see FIG. 3) or any other water container for converting tap water or bottle water into alkaline water. The alkaline water converter comprises a converter adapter 1, a cap 4, and a receptacle 5.

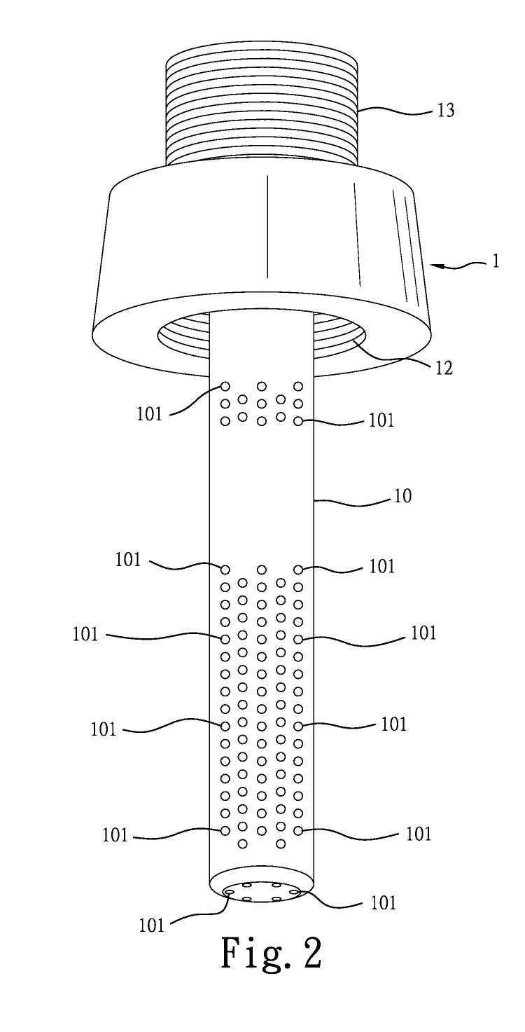

The converter adapter 1 (see FIGS. 1 and 2) comprises a through hole 11 vertically extending through opposing top and bottom sides thereof, a screw hole 12 located at the bottom side thereof around and in communication with the bottom end of the through hole 11 for threading onto a thread neck 31 of the water bottle 3 (see FIG. 3) or any other water container, an inside bearing wall 121 connected between the top end of the screw hole 12 and the bottom end of the through hole 11, an inside annular flange 1211 downwardly protruded from the inside bearing wall 121 around the bottom end of the through hole 11 and suspending in the screw hole 12, an alkaline filter component container 10 fastened to the inside annular flange 1211, and a connection neck 13 upwardly extended from the top wall thereof around the top end of the through hole 11. The alkaline filter component container 10 has a close bottom end and an open top end. The open top end of the alkaline filter component container 10 is fixedly fastened to the inside annular flange 1211 of the converter adapter 1. Further, the alkaline filter component container 10 holds therein a plurality of alkaline filter components 2, comprising a plurality of perforations 101 cut through the periphery and the close bottom end and a wire mesh filter 102 affixed to the open top end and disposed in the through hole 11. Further, the alkaline filter components 2 can be selected from the group of alkaline ore, tourmaline and trace minerals. Further, the connection neck 13 in this embodiment is an externally threaded neck.

The cap 4 comprises a bottom connection portion 41 detachably connectable to the connection neck 13 of the converter adapter 1. In this embodiment, the bottom connection portion 41 is a screw hole adapted for threading onto the threaded connection neck 13 (see FIG. 3).

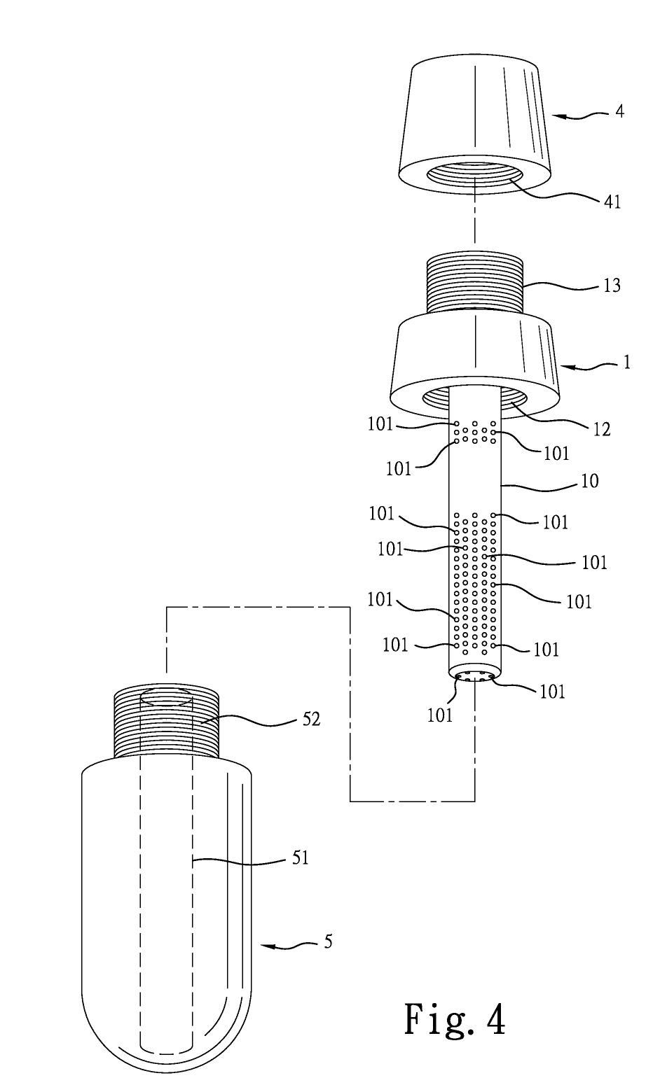

The receptacle 5 comprises a receptacle body 51 (see FIG. 4) for accommodating the alkaline filter component container 10 of the converter adapter 1, and a threaded neck 52 (see FIG. 4) for threading into the screw hole 12 of the converter adapter 1.

During application, the converter adapter 1 can be attached to the water bottle 3 by means of threading the screw hole 12 of the converter adapter 1 onto the thread neck 31 of the water bottle 3 to dip the alkaline filter component container 10 of the converter adapter 1 in the drinking water that is contained in the water bottle 3. When pouring the drinking water out of the water bottle 3 to a water cup for serving, the drinking water will be filtrated by the alkaline filter components 2 and then converted into alkaline water having smaller clusters of water molecules. The alkalinity of the alkaline water can survive the digestive system and change your blood's or body's pH. Further, the redox potential of the alkaline water has an effect on oxygen radicals in your cells. Further, the alkaline water is better at hydrating or detoxifying than regular drinking water.

In conclusion, the invention provides an alkaline water converter, which has the advantages as follows:

1. The converter adapter 1 can be conveniently fastened to a water bottle 3. When pouring the drinking water out of the water bottle 3 to a water cup for serving, the alkaline filter components 2 can convert the drinking water into alkaline water having smaller clusters of water molecules. The alkalinity of the alkaline water can survive the digestive system and change the blood's or body's pH of the person drinking the alkaline water. Further, the redox potential of the alkaline water has an effect on oxygen radicals in the cells of the person drinking the alkaline water. Further, the alkaline water is better at hydrating or detoxifying than regular drinking water. Further, the minerals and trace elements carried in the alkaline water help the activation of enzymes in the body and start the immune system of the person drinking the alkaline water, enhancing the functioning of body organs and the excretion of toxic harmful substances.
2. When not in use, the converter adapter 1 can be detached from the water bottle 3, and then received in the receptacle 5 and capped by the cap 4 for carrying.

While only one embodiment of the present invention has been shown and described, it will be understood that various modifications and changes could be made thereunto without departing from the spirit and scope of the invention disclosed.

What is claimed is:

1. An alkaline water converter, comprising:
a converter adapter comprising a through hole vertically extending through opposing top and bottom sides thereof, a screw hole located at the bottom side thereof around and in communication with a bottom end of said through hole for threading onto a thread neck of a water container, an inside bearing wall connected between a top end of said screw hole and a bottom end of said through hole, an inside annular flange downwardly protruded from said inside bearing wall around the bottom end of said through hole and suspending in said screw hole; and
an alkaline filter component container fastened to said inside annular flange, said alkaline filter component container comprising a close bottom end, an open top end fixedly fastened to said inside annular flange of said converter adapter, a plurality of alkaline filter components stuffed therein, a plurality of perforations cut through the periphery thereof and said close bottom end, and a wire mesh filter affixed to said open top end and disposed in said through hole of said converter adapter.

2. The alkaline water converter as claimed in claim 1, wherein said alkaline filter components is selected from the group of alkaline ore, tourmaline and trace minerals.

3. The alkaline water converter as claimed in claim 1, wherein said converter adapter further comprises a connection neck upwardly extended from the top side thereof around a top end of said through hole, and a cap detachably attachable to said connection neck to close said through hole.

4. The alkaline water converter as claimed in claim 3, wherein said connection neck is an externally threaded neck; said cap comprises a bottom connection portion threadable onto said connection neck.

5. An alkaline water converter, comprising:
a converter adapter comprising a through hole vertically extending through opposing top and bottom sides thereof, a screw hole located at the bottom side thereof around and in communication with a bottom end of said through hole for threading onto a thread neck of a water container, an inside bearing wall connected between a top end of said screw hole and a bottom end of said through hole, and a connection neck upwardly extended from the top side thereof around a top end of said through hole;
an alkaline filter component container fastened to said inside bearing wall of said converter adapter, said alkaline filter component container comprising a close bottom end, an open top end fixedly fastened to said inside bearing wall of said converter adapter, a plurality of alkaline filter components stuffed therein, a plurality of perforations cut through the periphery thereof and said close bottom end, and a wire mesh filter affixed to said open top end and disposed in said through hole of said converter adapter;
a cap detachably attachable to said connection neck of said converter adapter to close said through hole, said cap comprising a bottom connection portion connectable to said connection neck of said converter adapter; and
a receptacle comprising a receptacle body for accommodating said alkaline filter component container and a threaded neck for threading into said screw hole of said converter adapter.

6. The alkaline water converter as claimed in claim 5, wherein said alkaline filter components is selected from the group of alkaline ore, tourmaline and trace minerals.

7. The alkaline water converter as claimed in claim 5, wherein said converter adapter further comprises an inside annular flange downwardly protruded from said inside bearing wall for securing said alkaline filter component container.
